(19) United States
(12) Patent Application Publication
(10) Pub. No.: US 2017/0138083 A1
(43) Pub. Date: May 18, 2017

(54) MULTI-USE PARK FOR THE LIVING AND THE DEAD

(71) Applicant: Thomas William Van Den Bogart, Slinger, WI (US)

(72) Inventor: Thomas William Van Den Bogart, Slinger, WI (US)

(21) Appl. No.: 15/419,402

(22) Filed: Jan. 30, 2017

Related U.S. Application Data
(63) Continuation of application No. 12/981,730, filed on Dec. 30, 2010.
(60) Provisional application No. 61/291,580, filed on Dec. 31, 2009.

(51) Int. Cl. E04H 13/00; A61G 99/00

(52) U.S. Cl. CPC E04H 13/003; A61G 99/00; E04H 13/006; E04H 13/008; H04L 67/12

(57) ABSTRACT

A multi-use park for the living and the dead, which typically includes a bounded green space; asymmetric columbaria in the form of art objects, such as mosaics or sculptures; and a building for wedding ceremonies or celebrations, baptisms, graduation celebrations, retirement parties, picnics, and other events along the continuum of life. In other words the multi-use park, in one location, melds ongoing activities of the living, with remembering the dead. A method of use typically includes the step of a receiving payment to deploy the ashes of a deceased entity within the bounded green space of the multi-use park, wherein the ashes are deployed in an asymmetric columbarium having the appearance of an art object such as a sculpture or mosaic; and receiving payment to conduct a milestone life-continuum event, such as a graduation celebration, within the bounded green space of the multi-use park.

This application claims priority to U.S. Provisional Patent Application No. 61/291,580, entitled “Multi-Use Park for the Living and the Dead” and filed on 31 Dec. 2009, the substance of which is incorporated herein by reference.

### BACKGROUND

People go to cemeteries to bury and remember their dead. Typically cemeteries are limited to this purpose by law, tradition, or both. This is unfortunate, for at least two reasons.

First, for most people, death is a frightening prospect. Traditional cemeteries, and their practices, can reinforce this sense of foreboding and fear. After all, traditional cemeteries are devoted exclusively to the dead—and death is a subject many wish to avoid. Consequently, the design and layout of a traditional cemetery—symmetrical rows of tombstones or plaques; grid-like arrangements of compartments for bodies, as in a mausoleum; or grid-like niches in a columbarium—necessarily imports this historical view of death and the dead.

Second, traditional cemeteries require land, perhaps a large amount of land. Those who own and operate cemeteries may incur significant costs purchasing and maintaining property for this single use. If a substantial part of the cemetery is devoted to interring bodies of the dead, then cost goes up, because the space needed for interment is greater than the space needed to store urns holding cremated remains (or, of course, to receive sprinkled ashes). Furthermore, some land features, including hills, flood plains, areas near streams, marshy areas, and the like may not be suitable for interring the dead.

The result, then, is that traditional cemeteries reinforce the estrangement of death from other events on the continuum of life. And there is a psychological, and pecuniary, cost to devoting land solely to the dead.

### SUMMARY

I believe that a multi-use park for the living, and for the cremated remains of the dead, makes a significant break from past practices of traditional cemeteries and funeral homes. Rather than devoting land exclusively to the dead, a multi-use park of the present invention, and methods of using this park, meld, in an ongoing way, events along the continuum of life, including its end point, death (which, in a multi-use park, will typically be marked in a celebratory fashion). In other words, the multi-use park is a place where all narrative threads of life intertwine, helping reduce the stigma of death, and making available the green space (or land generally, given that multi-use parks in some locations, e.g. the American Southwest, may not be thought of as “green” spaces but rather as public outdoor space) as an ongoing resource of the community.

Unlike traditional cemeteries, a multi-use park does not receive and deploy non-cremated remains of previously existing entities (i.e., people or pets). Instead, the bounded green space receives, and deploys, only cremated remains (of people, pets, or both; or treated in some other way, e.g., by resomation, as discussed below, a way by which the mass and/or volume of remains is reduced, thereby potentially facilitating incorporation of the cremated remains into various art-like columbaria, whether by incorporation into the materials of construction of the columbaria—such as stained glass, or in compartments associated with the columbaria; but excluding intact bodies of the dead). The ashes may be sprinkled within the park (e.g., at a sprinkling garden within the green space) or deployed in urns, niches, or other such structures. Unlike traditional cemeteries and funeral homes, though, these structures are art objects in and of themselves, and are located throughout the multi-use park, thereby intermingling the ashes and memories of the dead with ongoing activities of life, whether special (e.g., a graduation celebration) or ordinary (playing chess by a quiet pond; or walking along a path, reflecting on and communing with nature and the surroundings).

In one representative embodiment, the ashes are stored directly in niches, in urns that are then placed in niches, or in some other fashion incorporated into, or stored in, aesthetically pleasing columbaria or structures shaped like objects of art, including abstract sculptures; sculptures of human figures, animals, plants, natural environments; and the like. For purposes of this application, such columbaria are denominated as an “artaleum-type” or columbarium or structure (or an Artaleum™) Unlike traditional columbaria, tombstones, and mausoleums, which are typically immediately recognizable for what they are—often austere, symmetrical structures that evoke the weight, solidity, and finality of death—and therefore import the traditional and cultural meanings normally ascribed to them—an artaleum-type columbarium, positioned within the multi-use park, is designed to blend in with other elements of the park, or serve as a harmonious focal point. Just as objects of art and sculptures in other public contexts draw the eye, evoking a perception of beauty, artaleum-type structures do the same. Furthermore, unlike traditional columbaria, mausoleums, and tombstones, artaleum-type columbaria are not segregated from various activities of the living that take place in the multi-use park.

In another representative embodiment, alone or in combination with the artaleum-type structure described above, ashes are deployed in a mosaicleum-type structure (or a Mosaicleum™); i.e., a series of individual niches or compartments each having an individual appearance that is aesthetically pleasing, and which together effect an appearance as a whole that is aesthetically pleasing and harmonious. In other words, just as a mosaic is typically defined as an image or decorative picture composed of small, separate pieces of colored stone, tile, or glass, a mosaicleum-type structure is composed of separate niche or compartment designs that, together, cooperate to effect an artistic image.

In addition to artaleum-type and/or mosaicleum-type columbaria, versions of the invention may also include other structures for containing ashes of the dead, whether in niches, urns, or other compartments. For example, ashes may be deployed in stone or rock formations; benches; tree-like structures; and the like. These structures, like the artaleum-type or mosaicleum-type columbaria noted above, blend harmoniously into various settings within the multi-use park. For example, the chess match referred to above may take place on a stone bench, the bench itself containing ashes of those who have passed on.

It should be noted that, rather than place ashes in individual niches, urns stored in niches, compartments, or the like, ashes may be used as part of the materials of construction of an artaleum-type columbarium, a mosaicleum-type columbarium, or other columbaria like those described above. For examples, ashes may be incorporated into glass that then is used to help construct one of the aforementioned columbaria. Or ashes may be mixed with stone, metal, or other materials (e.g., be blended in with materials used to construct the exemplary stone bench mentioned above). For example, the glass comprising ashes may be formed into glass flower petals. These petals may be attached to other components, such as a metal stem, thereby forming an aesthetically pleasing representation of a flower. The stem itself may be hollow, and function as a container capable of holding memorabilia or ashes (e.g., ashes not used in preparing the glass petals).

In another version of the invention, the multi-use park includes a building configured to accommodate milestone life-continuum events such as weddings, baptisms, graduation celebrations, retirement celebrations, corporate meetings, community events (e.g., festivals, cookouts, memorials, celebrations, parades, fairs, etc.), and the like. Any of the aforementioned categories of columbaria may be placed in public spaces within the building such that baptisms, weddings, or other such events are conducted next to or near these columbaria which, as noted above, are aesthetically pleasing and harmoniously a part of the building's architecture and space. Such melding of milestone life-continuum events, such as weddings or graduation celebrations, along side spaces and structures holding the ashes of loved ones that have passed on, could help people to overcome the stigma of death.

It should be noted that, in addition to the mosaicleum- and/or artaleum-type columbaria described above, traditional columbaria, which often are symmetrical in design, could also be deployed in the multi-use park for the living and the dead. Note, too, that a mosaicleum- and/or artaleum-type columbarium may, in some representative embodiments, be symmetrical in form. For example, ashes of a deceased person may be blended in with the raw materials for forming tinted glass, such as tinted glass panels. Different tinted glass panels, then, even if square in shape, when put together, can form a beautiful stained glass art form, and be appreciated as such—while at the same time serving as a columbarium.

Whatever the form, some versions of the aforementioned columbaria may be designed to receive not only the ashes of previously existing entities, but also other memorabilia associated with the previously existing entity. Also, as is evident from the above description, an overall goal in the design of the columbaria is to provide an aesthetically pleasing environment in which the living pursue events of the living (including, for example, milestone life-continuum events such as a baptism, birthday celebration, confirmation, coming-of-age event, graduation celebration, wedding, award ceremony, retirement celebration, and the like), along side ashes of the dead, thereby melding narratives of those who live with narratives of those who have passed on.

Exemplary versions of a multi-use park for the living and the dead incorporates garden elements that help promote this melding of ongoing events of the living alongside ashes of the dead. So, for example, the multi-use park may include: walls, fences, hedges, or the like that help provide boundaries within the green space (and privacy for activities such as reading, meditation, solitude, and prayer), with some of these forms possibly serving as columbaria (e.g., a mosaicleum-type columbarium serving as a wall); walls, fences, hedges, or the like around the perimeter of the bounded green space, which, again, may incorporate ashes of deceased persons or pets; asymmetrical design elements that help distinguish the multi-use green space from traditional cemeteries, including various embodiments of the aforementioned columbaria; layered plants arranged to promote a perception of depth, even in small areas; evergreen plants so that greenery, a symbol of life and serenity, is promoted throughout the year; plants and materials selected from the region in which the green space is located, thereby helping anchor the multi-use park in the narratives of nearby communities and the surrounding region; and other such design elements, discussed in greater detail in the Description section below.

Representative versions of the multi-use park for the living and the dead also include means by which narratives of the dead are preserved, and made accessible, to those visiting the park. These narratives may be made available through traditional means, such as with plaques memorializing the dead. Or these narratives may be made available in non-traditional ways. In one representative version of the multi-use park, narratives are broadcast wirelessly in at least a portion of the park. These narratives are received, at the option of visitors to the park, using portable devices (e.g., a mobile phone with a visual display and capable of receiving wireless transmissions, such as transmissions over a Wi-Fi network) or a kiosk located in a small pavilion or chapel-like building.

Note, too, that the multi-use park need not be limited to narratives of the dead. Traditional and non-traditional means may be used to present narratives of milestone life-continuum events celebrated in the park (e.g., weddings); and other narratives, including, for example: narratives about the surrounding community (past and present), region, or other geographical entity; natural, political, military, religious, historical, or other narratives; or combinations thereof. Again, the presentation of narratives of both the living, and the dead, helps to meld the purposes for which the multi-use park exists (in part for historical and/or educational documentation).

The present invention encompasses methods of using the multi-use park for the living and the dead. For example, in some versions, the method encompasses for-profit operation of the park. Thus, in one representative embodiment, the method includes the steps of: (a) deploying ashes of a previously existing entity within the bounded green space; (b) receiving a fee for said deployment; (c) accommodating a milestone life-continuum event within the bounded green space different from step (a); and (d) receiving a fee for said accommodation. Because this version of the invention reflects a for-profit entity or entities, steps (b) and (d) are both taxable events at one or more levels of government (e.g., local, regional, state, or federal). Furthermore, steps (a) and (c) are not necessarily segregated from each other in time or space. As noted above, ashes of the dead may be deployed in a variety of columbaria located through out the park. If a wall encompasses the multi-use park, then the wall itself may be a mosaicleum-type columbarium (which might further include water features, such as a water fall, and other artistic expressions, including artaleum-type columbaria that are part of, or proximate to, the wall-like moasaicleum-type columbarium surrounding the multi-use park). Furthermore, in a private setting within the green space, such as a garden setting for solitude, the setting might include a bench structure having niches in which ashes of the dead are deployed. Or, in an outdoor amphitheater adapted for theatrical or musical performances, a mosaicleum-type columbarium may form a wall that is part of, or near, the amphitheater. Or, in a multi-purpose building used to accommodate weddings or other such celebrations and events, an artaleum-type columbarium having the appearance of an abstract sculpture may be present in the building. In all of these cases, ongoing life events occur along side ashes of the dead, in contrast to traditional cemeteries where the dead are segregated, typically in symmetrical fashion within a quadrant, apart from the living. Note, too, that representative versions of these methods exclude deploying non-cremated remains of previously existing entities in the multi-use park (note, however, that if some portion of the park was devoted to a crematorium, then intact remains of the dead would, prior to cremation, be within the confines of the park; note too that intact remains may be exhumed from a grave or mausoleum in a traditional cemetery, cremated, and deployed in a multi-use park of the present invention).

These and other representative embodiments of the invention are described below.

### DRAWINGS

FIGS. 1A, 1B, and 1C show representative versions of columbaria in multi-use parks for the living and the dead.

FIGS. 2A, 2B, 2C, 2D, and 2E show representative versions of columbaria in multi-use parks for the living and the dead.

FIGS. 3A, 3B, 3C, and 3D show representative versions of columbaria in multi-use parks for the living and the dead.

FIG. 4 shows a representative version of a multi-use park for the living and the dead, from a birds-eye view.

### DESCRIPTION

A multi-use park for the living and the dead includes a bounded green space, the boundary of which typically coincides with the property line or boundary of the green space (or geographically aesthetically pleasing “space,” for those locations, such as the American Southwest, where the predominant flora indigenous to that location do not evoke an overall impression or perception of the color green, or greenery). The multi-use park also comprises artaleum-type and/or mosaicleum-type columbaria which, as described elsewhere, are art pieces, often asymmetrical art pieces, in and of themselves, that happen to contain ashes of the dead (e.g., artaleum-type columbaria such as, for example, an abstract sculpture; and/or mosaicleum-type columbaria such as, for example, an arrangement of niches, each of which has different markings or images or surface contours disposed thereon, the combination forming a theme or overall abstract appearance). These columbaria may be relatively large. For example, an outdoor, abstract, asymmetric, metal sculpture, serving as both an aesthetically pleasing focal point in some outdoor space and as a columbarium, may be 20 feet, 25 feet, or 30 feet or more in height. The multi-use park also includes a building, pavilion, or other structure for accommodating milestone life-continuum events (e.g., weddings, graduation celebrations, and numerous other events that people mark out as important along a life continuum or life span). Note too that the multi-use park also accommodates ordinary, everyday activities of the living . . . such as walking, picnics, chess, the toss of a Frisbee, the reading of a book by a pond, and other such pursuits. Furthermore, the multi-use park includes garden, landscape, and/or architectural elements that can help to demarcate the bounded green space of the multi-use park into smaller spaces, with these smaller spaces conducive to concurrent or sequential life activities including, for example, the celebration of milestone life-continuum events; solitude and meditation; walking along a path through a copse of trees; a play ground for children; focal points such as ponds, fountains, flower gardens, and other such elements; a gazebo for reading; a pavilion for performances; and other features, including various combinations thereof. The multi-use park also incorporates tangible objects and/or ways by which narratives of the dead, and of the living, are presented. The multi-use park, then, is an ongoing resource to those within the community where the park resides, both for ongoing activities of the living, and as a final resting place for those who have passed on. In this way the traditional taboos and fears associated with death may be overcome, or alleviated. Additional detail about representative embodiments of the invention, and the elements thereof, are described below.

### Representative Versions of Bounded Green Spaces

As noted above, cemeteries traditionally include a bounded green space selected to accommodate the interment of intact bodies of the dead. Typically that's it. Traditional cemeteries are not designed to accommodate various activities of the living along side remains of the dead. This may be due to law (e.g., zoning, public health issues), tradition (e.g., an accepted norm that it is disrespectful to laugh and sing and play and celebrate in the same space as the dead), or psychological state (e.g., fear of death). It's true, of course, that some people, in the privacy of their own homes, may make the individual choice to display an urn containing the ashes of a loved one in a living room where people, every day, go about living their lives. This is, of course, far afield of a multi-use park, available to the public, where the ashes of deceased entities, whether human or animal, are deployed in harmonious and aesthetically pleasing ways throughout the park, along side, and intermingled with, various other public uses—public uses different from deploying and remembering the dead.

Traditional cemeteries, given their sole purpose, are limited as to the land that may be used. Some features of geologic interest and beauty—hills, streams, rough terrain, wetlands, and the like—may not be well suited to interring the intact remains of the dead. Furthermore, given the traditional arrangement of burial sites for coffins—grid-like arrangements of tombstones, metal plaques, or other such markers—larger expanses of reasonably flat land may be required. Furthermore, whatever the nature of the land devoted to the cemetery, it is used for this sole purpose.

By contrast, the bounded green space used for a multi-use park for the living and the dead can be geologically complex, incorporating one or more of the features mentioned above that may not be suitable for a traditional cemetery. Furthermore, the amount of land devoted to a multi-use park for the living and the dead may be smaller, given that the multi-use park excludes the intact remains of deceased persons and animals. As noted elsewhere, the inventive multi-use park receives only cremated ashes of deceased entities (or processed in other ways, e.g., resomation, but excluding intact bodies of the dead), whether sprinkled at locations within the park, or deployed in urns, containers, niches, compartments, or other objects that are structurally part of the green space elements as denoted earlier (walls, artwork, stepping stones, building elements etc). Accordingly, in some representative versions of the invention, the bounded green space may be 3 acres or less; suitably 2 acres or less; specifically 1 acre or less. Of course larger areas may be used. Also, because intact bodies of the dead are not deployed within the bounded green space, the numbers of deceased entities deployed in the space may be large. In some representative versions of the invention, the numbers of deceased entities deployed per acre may be between 50 and 10,000; suitably between 100 and 5,000;
specifically between 200 and 4,000; between 250 and 3000; between 300 and 2000; etc. Typically a significant portion of these numbers of deceased entities will be stored in mosaicleum-type columbaria, artaleum-type columbaria, or both. As will be appreciated, the total number of deceased entities deployed per acre will depend on several factors including whether or not the mass, volume, or both of the cremated ashes are reduced prior to deployment; the nature and capacity of any mosaicleum and/or artaleum-type columbaria located in the bounded green space; whether or not ashes are deployed in the materials of construction used to compose or make a mosaicleum and/or artaleum-type columbarium, deployed in urns that are placed in niches, or deployed in niches themselves; etc. And, whatever the nature of the land, it serves as an ongoing resource for the living. Accordingly, the green space is typically selected and/or designed to reflect the community in which it is located (or nearby communities). If, for example, the multi-use park is in or near a community located along a river that was the backbone of industry for decades, then the bounded multi-use park can be designed in a way that captures and honors the river-based industries that served the community (e.g., fishing, logging, paper production, and the like). The multi-use park, then, reflects good stewardship: the land is available, in an ongoing way, to the community, for a variety of purposes, including remembering those who have passed on.

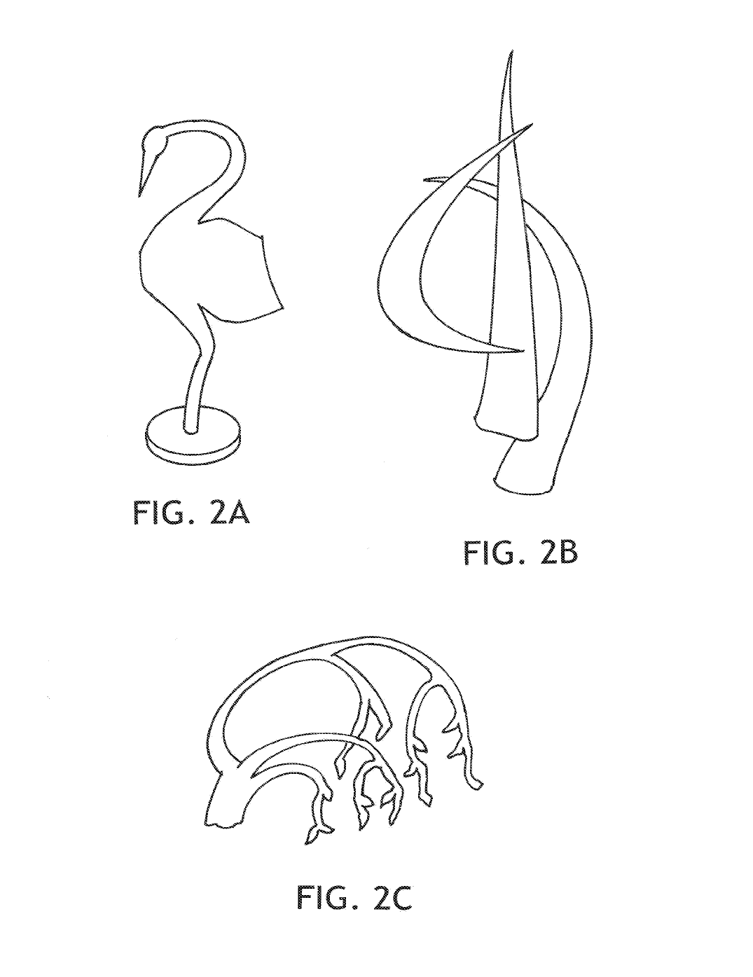

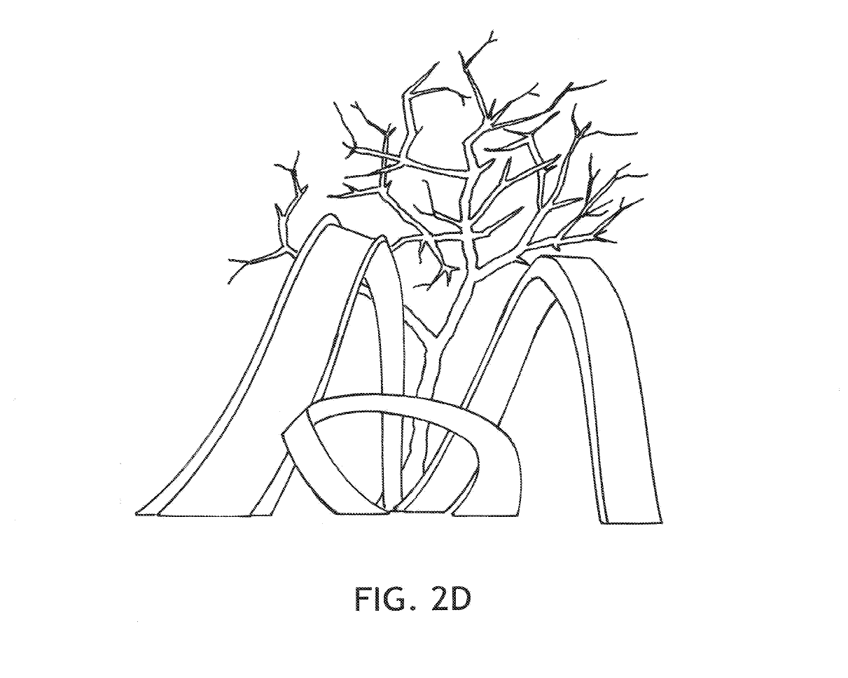

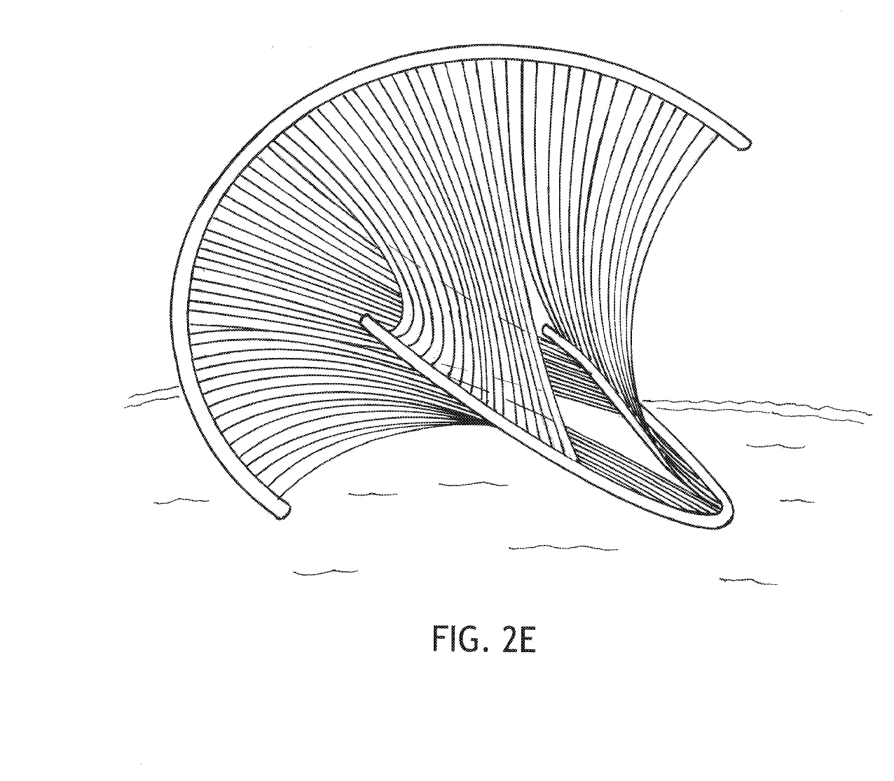

In one representative version of the invention, the multi-use park for the living and the dead comprises a bounded green space that includes one or more water features, whether natural or man-made. The water feature may be a pond, fountain, stream, or the like. Pumps and other mechanical devices may, of course, be used to circulate and aerate the water, especially if the water is to host fish or other living creatures. One or more water features may be placed near, adjacent to, or form part of, one or more columbaria or sprinkling gardens. For example, an artaleum-type columbarium having the appearance of heron-like birds (depicted in FIG. 2A) may actually be placed in a pond, thus serving as an aesthetically pleasing art object and focal point—one in harmony with its surroundings—and as a structure containing ashes of the dead (whether ashes are housed in separate compartments within this artaleum-type columbarium, or blended in with the materials of construction of the columbarium, or both).

In some versions of the invention, the multi-use park for the living and the dead is located in a setting that includes one or more representative features of the terrain and plants of the surrounding region. Thus, for example, in the American Southwest, a multi-use park for the living and the dead may comprise a bounded green-space that includes cacti, rock formations, and other such features indigenous to, and reflective of, the Southwest. It should be noted, again, that the term “green space” denotes a natural, outdoor setting but which may not, in some circumstance, comprise lush, green plants such that the color “green” predominates. Because the color green represents life and the rhythms of nature, it is often desirable, however, to choose locations, plantings, landscape designs, and architectural features that emphasize, at least in part, the color green. Accordingly, some exemplary multi-use parks include natural, or planted, stands of evergreen trees and/or plants so that the color green, at least in portions of the park, is present year round.

For this same reason, a building for accommodating ongoing life celebrations, and other structures located in the bounded green space, will frequently reflect the architecture of the surrounding area. Thus, for example, architectural designs reflecting the work of a local architect may be employed. A multi-use park in the American Southwest, then, would typically include adobe-type structures that reflect a design that is commonly used in this region of the country.

In some versions of the invention, the multi-use park for the living and the dead includes geologic features, such as rock and rock formations that reflect the surrounding region. So, for example, a multi-use park located in the upper American Mid-west may comprise a bounded green-space that includes land features and rock reflecting glacial action. For example, glacial action produces various geologic features, including low-lying areas in which water accumulates to form ponds and lakes, and moraines and other such deposits. Thus, a multi-use park in this region of the country may be located where such land features are present.

The multi-use park may employ state-of-the-art technologies to promote both “green” and “SMART” land use and planning. In general, the words “green” and “SMART” denote principles of good stewardship: seek to minimize waste and pollution; seek to care for the fauna and flora in a given location; seek to make land available, in an ongoing way, to communities; think and plan for the future, in a way that reflects concern and compassion for people, animals, and plants. For example, resomation encompasses processing the body of the deceased so that at least some portion of the body is transformed into a liquid or liquid-like substance.

Resomation produces few, if any, emissions, compared to cremation processes involving some form of combustion. Thus some versions of the invention involving processing the body of the deceased using resomation technology, and then deploying the resulting liquid and/or solid within the multi-use park (e.g., by a technique akin to sprinkling ashes, but here involving the dissemination of the liquid or substance comprising liquid into the environment, perhaps in spheres or other containers that dissolve or break apart over time, thereby facilitating growth of other forms of life (e.g., plants and trees)—if desired, some or all of the liquid or substance comprising liquid may be placed in planter or other structure that contains plants, thereby helping assure survivors that the remains of one who has passed on have likely, in part, been transformed into a growing, living plant rooted in the planter or structure). In some versions of the invention, filtration is used in conjunction with resomation to produce different streams (some liquid and/or mass passing through a filter, and some liquid and/or mass not passing through a filter, or plurality of filters; with the separated streams directed to different end states, one of which would be deployment of output from resomation and filtration in the multi-use park, as described above, for example).

The bounded green spaces described above are exemplary in nature. Numerous other bounded green spaces may be used as sites for a multi-use park for the living and the dead, so long as the space includes various other natural and/or person-made structures, including artaleum- and/or mosaicleum-type columbaria; a building or other structure for accommodating ongoing life events along side ashes of the dead; and tangible objects and/or electronic forms embodying narratives about the dead, the living, or both. Note that “along side” may mean that ongoing activities of the living are adjacent to, or on, a structure containing ashes of the dead (e.g., a couple meeting at a bench in the multi-use park, with the bench itself incorporating ashes of the dead). The phrase also encompasses life activities near such columbaria (e.g., a game of catch in the shadow of a 25-foot tall, abstract, metal sculpture that serves as a columbarium). These additional elements are described below.

### Artaleum-Type Columbaria

As noted elsewhere, the dead are often deployed in symmetrical fashion, whether in a mausoleum, a traditional grid-like columbarium, or row upon row of grave markers. Ashes of the dead may be stored in individual urns shaped like vases, or plaques, or numerous other shapes that reflect the passions or joys of the deceased and/or the preferences of survivors.

In contrast to these containers and structures, Artaleum-type columbaria are aesthetically pleasing sculptures or art objects, often asymmetric, and which serve both as a focal point in a public space in the multi-use park, and as a structure for deploying the ashes of a plurality of deceased persons, whether or not the ashes are, at least in part, commingled with the materials of construction (e.g., as occurs when ashes of one or more deceased persons is intermingled with the materials of construction, such as glass particles when forming glass) or, alternatively, stored in separate compartments (e.g., directly in a compartment or niche; or indirectly, as when ashes are placed in an urn or container, which is then placed in a compartment or niche in the columbarium). For those asymmetrical artaleum-type columbaria that do contain niches, the niches themselves are frequently asymmetrical (in part, in some versions of the invention, to help effect the overall asymmetrical nature of such columbaria).

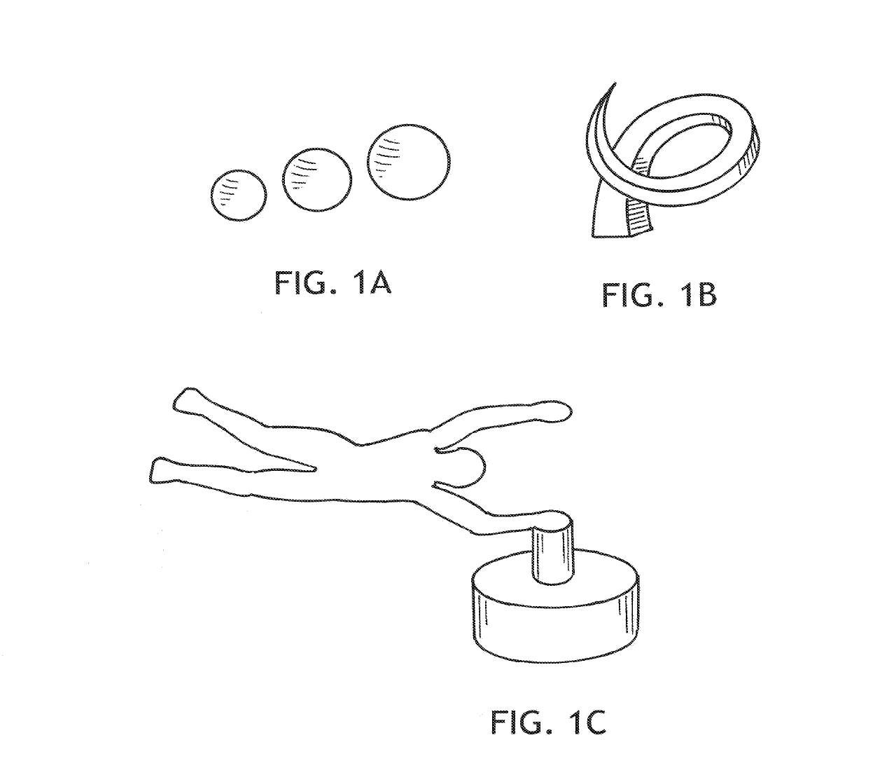

FIGS. 1A, 1B, 1C, 2A, 2B, 2C, 2D, and 2E depict representative versions of artaleum-type structures that may be located within a multi-use park for the living and the dead. FIG. 1A, for example, depicts a representative version of an abstract sculpture that may be made of metal, stone, glass, or other materials. The sculpture can also be made from materials that may be considered non-traditional in the death-care industry, including, for example, glass and plastic. Furthermore, the art object may be made by casting, cutting, molding, assembling, and otherwise shaping the materials of construction into desired shapes. Depending on the material, the art object can be made out of a solid, with compartments then cut into the solid. Or, alternatively, a frame may be constructed, around which are placed panels to form the exterior of the art object. Another possible method of construction is to use conventional casting techniques to make the art object or sculpture.

In this exemplary version, the columbarium is comprised of three, separate spheres, placed in a pleasing arrangement, here, for example, on a hill. The size of these spheres can be varied. If, for example, the spheres house individual niches or compartments for ashes of the dead, then the size of the spheres can be selected to accommodate the desired number of niches or compartments. FIG. 1A does not show these individual niches or compartments. Conventional techniques may be used to cut, mold, cast, or construct niches or compartments in the art object so that the ashes of deceased entities may be placed in said niches or compartments, either directly, or indirectly (e.g., the ashes are placed in an urn or container, which is then placed in a compartment or niche). The artaleum-type structure, such as these spheres or the representative examples that follow, may be constructed so that the ashes, once deployed, are not retrievable. Alternatively, the artaleum-type columbarium may be made so that urns containing ashes of deceased entities are removable.

Other representative versions of artaleum-type columbaria include other geometric shapes, or a plurality of such shapes, that incorporate niches or compartments into which ashes are permanently or retrievably placed (or in which ashes of deceased entities are blended in with the materials of construction of the structure).

FIG. 1B shows a three-dimensional curvilinear, abstract sculpture that is akin to a curlicue. A number of other such abstract shapes may be made. This type of structure, as with others, can be designed in a manner that allows for the piece to be constructed in phases. In other words, as time goes on, additional niches could be added by extending and adding to the art piece.

FIG. 1C shows a human figure, flying through the air, with the hand of the figure attached to a cylindrical base. Of course human figures in various poses, and of various ages, young or old, may be formed as an artaleum-type columbarium. This type of artaleum, as with others, can be constructed to allow the piece to move, rather than being static. For example, the hand of the cylinder could be attached to a rotatable cylinder, with this cylinder then attached to a motor to drive rotation of the cylinder, and therefore the human figure. Also the design may be such that the art object is attached to a base in such a way that wind and/or rain affect the position of the art object (e.g., wind may cause the object to move in a fashion similar to the movement of a weather vane).

FIG. 2A depicts a heron-like bird. Artaleum-type columbaria encompass representations of any animal. Furthermore, the columbarium may encompass a plurality of objects, whether of the same, or different type. So, for example, a columbarium may comprise structures resembling two or more heron-like birds, perhaps of different size, together representing a family or group of herons.

FIG. 2B shows and abstract art object with upward sweeping, curvilinear structures that evoke the image of a flame or tongues of fire. An artaleum-type columbarium may also incorporate other natural elements into the design such as water flow, flames, sound or electrical light to enhance the artistic nature of the piece.

FIG. 2C shows a sculpture of a stylized depiction of the hanging branches of a tree.

FIG. 2D shows a relatively large, abstract columbarium in front of a tree. As noted elsewhere, the various columbaria disclosed in this document may be relatively large art objects that command the attention of those who view the object.

FIG. 2E shows a sculpture somewhat reminiscent of a strand of DNA—i.e., a helical structure in which two curvilinear tubes at the perimeter are attached to each other by a series of spokes. As is noted elsewhere, ashes of deceased entities may either be mixed with the materials of construction of the art-like columbarium (optionally after processing to reduce the mass and/or volume of the remains, as with the process of resomation, which is described elsewhere in the application), or be incorporated into compartments or cavities in the columbarium. For example, each of the spokes depicted in FIG. 2E may be hollow tubes, in which case cremated remains of deceased entities may be deposited in these hollow tubes (e.g., one spoke, or hollow tube, for each deceased entity).

These representative versions, and numerous other embodiments, may be selected to be compatible with the general tastes and preferences of the communities near the location of the multi-use park for the living and the dead.

Furthermore, the selected artaleum-type structures can, where possible, be made, at least in part, using materials from the region in which the multi-use park is located. Of course the design needs of the columbarium may be such that materials from elsewhere are necessary.

It should also be noted that artists living near a multi-use park for the living and the dead, and whose work is thought to represent that area or region, may be employed to craft designs serving as artaleum-type columbaria. Alternatively, works by deceased artists from that area may serve as inspiration for artaleum-type columbaria representative of the region in which the multi-use park is located. This offers the community a way to celebrate the history of the community (in this case the artist) who may have played a significant role in the community. Likewise the architectural structure of the celebration hall or other such building within the park can reflect the architectural design of the community or a style of a famous architect from that community.

It should be evident that these artaleum-type columbaria, which are often asymmetrical, may be placed in various locations around a multi-use park for the living and the dead. For example, a focal point in the park can be a water feature, such as a pond or fountain, the centerpiece of which is an artaleum-type columbaria, such as a representation of children dancing in the water; or a representation of fish leaping from the water, and numerous other such art objects that are aesthetically pleasing to the eye. The artaleum-type columbarium, then, blends in harmoniously with the surrounding features, which may include, for example, benches for people to sit and listen to the water as it moves or sprays, depending on the specific features of the fountain. This representative embodiment helps accomplish the melding, in one place, of two kinds of activities: deploying and remember the dead; and various life activities, including, for example, the photographing of a couple who have just become engaged; reading; meditating; and the like.

Artaleum-type columbaria may be placed in relatively flat grassy areas; on hills; near streams; near or in structures such as buildings, pavilions, and outdoor amphitheaters; and numerous other locations within the bounded green space of the multi-use park for the living and the dead.

As is true for mosaicleum-type columbarium (discussed in more detail below), an artaleum-type columbarium may be fixed in size at the outset, or may grow over time as additional niches are attached. The niches may be permanently sealed, or have removable covers. Each niche may be the same size and type (e.g., one compartment), or different sizes and types (e.g., some niches of a certain size and having one contiguous volume; other niches of a different size, perhaps comprising two or more separate compartments, which might be used, for example, to keep separate the ashes of two deceased persons, or to keep the ashes of one deceased person and memorabilia; etc.). The columbarium may maintain the same overall appearance, regardless of the number of niches being used. Or the columbarium may change its appearance over time (e.g., used niches, and their corresponding covers or facing, have one appearance when not used; and a different appearance when used). Or the columbarium may not comprise niches, but instead incorporate ashes into the materials of construction.

Also, as is discussed below, individual signifiers identifying ashes contained in a particular niche, or urn within the niche, will typically not appear on that portion of the columbarium presenting an aesthetically pleasing art form to the eye. Thus, for example, an artaleum-type columbarium will usually not have metal plates, visible to the eye of someone viewing the art object as a whole, on each niche cover or door (with, for example, the name, date of birth, and date of death of the person whose ashes are contained therein). Instead, such signifiers, if employed, are typically positioned so that the aesthetically pleasing image is preserved. This isn't to say, however, that such name plates, or other such signifiers, are never employed on the surface of the columbarium, or individual niches, such that they are visible to the eye of an observer of the art form. Generally, however, such signifiers are not visible. As is discussed below, electronic forms, such as radio-frequency identification (“RFID”) tags may be employed. Such tags are unobtrusive, yet can be used to provide information about a person or pet whose ashes are contained in a niche. As a backup approach, the person's name or other unique identifier can also be associated with a niche in some way (e.g., an engraved number on the inside of a niche cover, and which is unique to that particular niche).

As is evident from the exemplary forms described above, a variety of different art objects may be designed to incorporate the ashes of the dead, thus serving as both an aesthetically pleasing art object, and a columbarium. Many other forms, abstract or not, may be chosen as an artaleum-type columbarium.

### Mosaicleum-Type Columbaria

Another columbarium structure that can be employed within the bounded green space of the multi-use park for the living and the dead is a mosaicleum-type columbarium. Like the columbarium described in the previous section, and again, in contrast to the grid-like, modular columbaria that are traditionally used, the mosaicleum-type columbarium is preferably asymmetrical. Mosaicleum-type columbaria generally are comprised of individual niches or compartments, each niche or compartment having its own visual appearance, with the combination of these niches or compartments cooperating to produce an overall theme or image. Note, however, that this columbarium does not have to include compartments or niches. Ashes of the dead may instead be blended into materials used to make the mosaicleum-type columbarium.

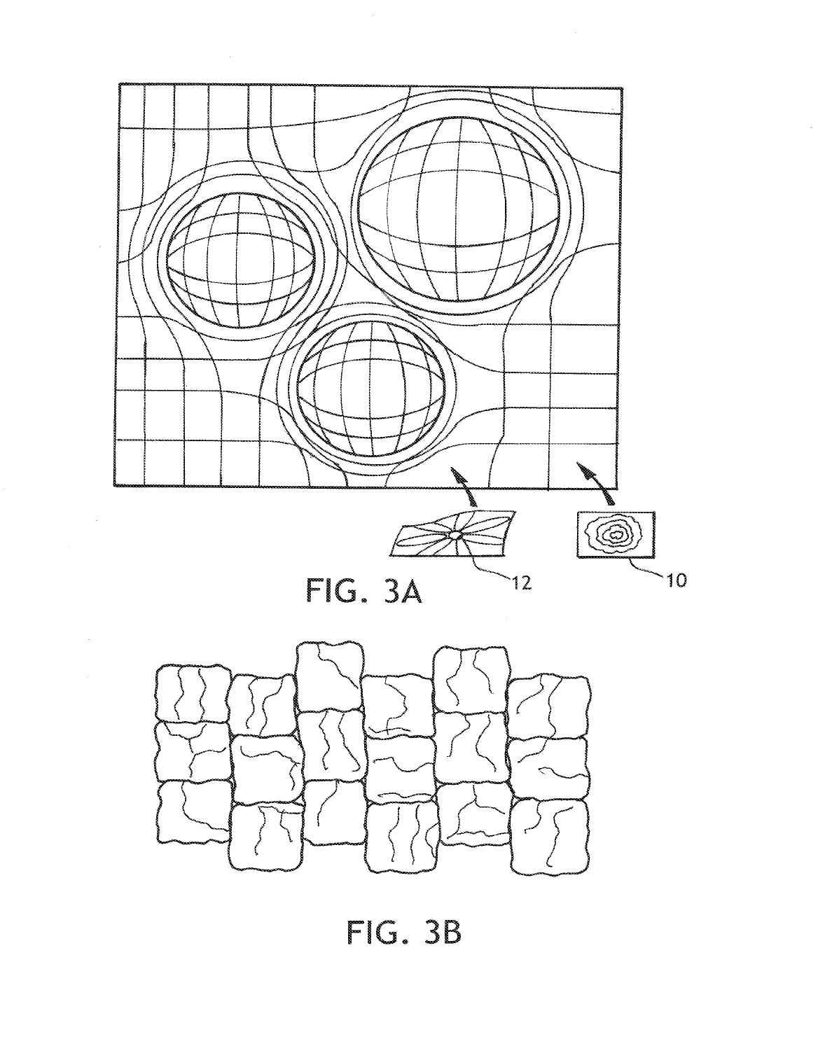

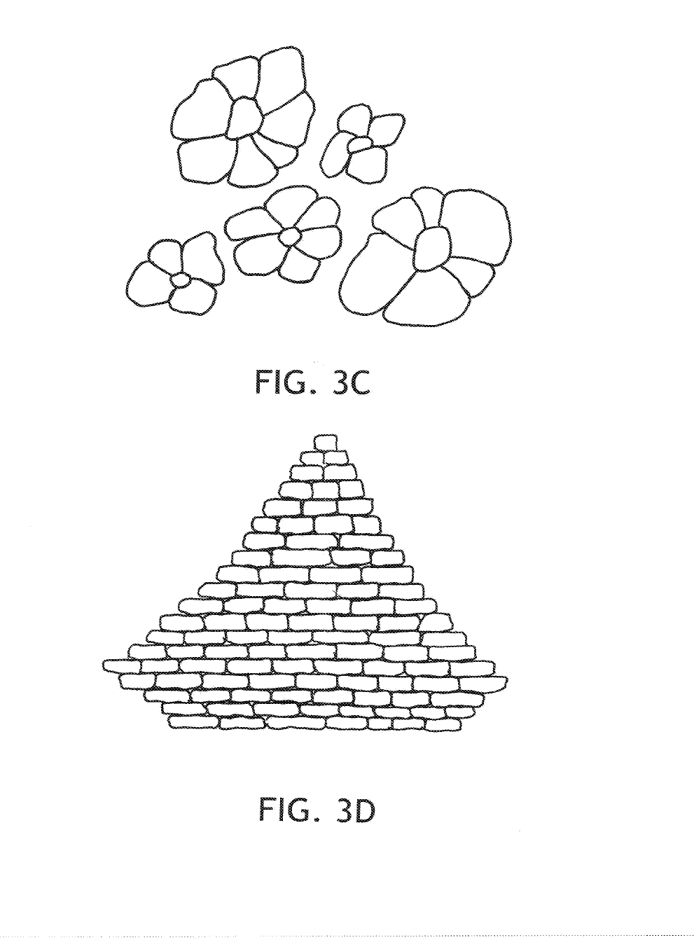

FIG. 3A, for example, shows a columbarium in which each of the individual niches cooperates to form the visual appearance of three multi-faceted spherical objects. In effect, the niches form the appearance of at least some of the facets of the spheres, and cooperate to form the overall image of the spheres. And so each niche, or at least a significant number of the niches, each possess unique markings, or a unique surface, or a combination thereof, so that the niche has a unique visual appearance compared with the other niches. For example, in some versions of the invention, each niche may have a different floral pattern, such as the representative floral patterns 10 and 12 corresponding to facets or faces of the mosaic. In FIG. 3A, these representative floral patterns are shown separately from the columbarium. Note, too, that these representative floral patterns, and the boundary of these patterns (as shown in FIG. 3A), may correspond to the boundaries of the niches themselves—i.e., the niches are themselves asymmetric. Alternatively, the overall columbarium may be divided into niches of uniform size (e.g., a uniform array of square niches having square covers). The pattern on the surface of each niche, whether asymmetric or not, may be abstract, or a recognizable object (e.g., plants, flowers, animals, insects, landscapes, people, astronomical objects, fish, buildings, etc.) Yet, when the niches are combined, they effect an overall appearance that is different from the appearance of individual niches, and is also aesthetically pleasing as a whole. For the mosaicleum-type columbarium depicted in FIG. 3A, for example, the face of the art object could be hammered metal, such that the surface of the spheres protrudes outward from the main surface of the columbarium. Furthermore, if made out of metal, the surface of the work could have a mottled, complex appearance. The columbarium may be made so that ashes of the dead are retrievable, or not retrievable. If retrievable, then the ashes of a deceased person are typically first placed in a container, usually called an urn, which itself is then placed in a compartment, usually called a niche, in the columbarium. Whether placed in an urn or not, ashes of the deceased person may be processed to facilitate placement of the ashes into small or asymmetrical spaces in a columbarium (e.g., by vacuum packing the ashes; by applying heat and pressure to compress the ashes, perhaps to the point of forming jewel-like materials that in and of themselves may help accentuate or form the art object; by comminution, perhaps at low temperatures; and the like. Furthermore, as discussed elsewhere, remains of the dead may be processed by resomation, alone or coupled with other processes such as filtration, comminution, heat and/or pressure treatment, and the like, to produce an output that is more readily accommodated by the various columbaria described in this document. These niches may be part of the columbarium such that the front of the columbarium itself has separate doors, or covers, one for each niche, giving access to the interior of the niche, and the urn or container therein. So, for example, the columbarium depicted in FIG. 3A might house an array of 35 niches: 5 niches along a column, top to bottom; and 7 niches along a row, left to right. The visual appearance of the art object, then, might have discrete recesses demarcating, for example, 35 square-shaped covers—each cover having disposed thereon unique markings, graphics, surface contours, or some combination thereof—which together cooperate to give the appearance of three 3-dimensional spheres. Alternatively, a conventional grid-like array of compartments may be employed, over which is placed an object of art such as that depicted in FIG. 3A and which, if the niches are to be accessible (e.g., to allow access to urns placed therein), may be moved to achieve access. The overlying work may be on hinges, or slidably placed on rails on a wall, or hung by a system of cables, or otherwise placed so that it stably rests over the conventional columbarium underneath, but which may be moved for access (if desired). In another version, the overlying work may be fixed in its location, but the conventional array of niches may be moved for access to individual niches. For example, a conventional grid-like columbarium might rest on wheels or castors allowing for the columbarium to be moved away from the overlying main structure (i.e., art work), thereby allowing access for placement and/or retrieval of ashes and/or memorabilia.

Note, however, that the columbarium may represent a permanent installation with the word “permanent” conveying the sense, in this case, that once ashes are deployed in it, they are no longer accessible (i.e., the ashes are now “permanently” part of the columbarium). The mosaicleum-type columbarium may be made in a number of ways to achieve this. For example, the columbarium may be made to have an array of compartments, with a cover over each compartment, each cover having disposed thereon unique markings, graphics, surface contours, or some combination thereof, which together cooperate to give the appearance of three 3-dimensional spheres (for the representative example presented in FIG. 3A). Unlike the version described above, however, once ashes are deployed in a compartment, the cover would be sealed or attached in a way that the ashes were not readily retrievable. In this case, the ashes might not be placed in an urn, with the urn then being placed in the compartment or niche. Instead the ashes might be placed directly in the niche; or in a container that is utilitarian, rather than decorative (e.g., a plain, a plastic bag-like storage device).

Note too that cremated remains may be vacuum packed in a plastic container or bag to further protect and compact them for optimal storage by reducing the volume required to store them. The bag would be flexible to allow the container to take on the unique shape of a niche, whether the niche is part of an artaleum-type or mosaicaleum-type columbarium.

In some representative versions, the outer perimeter, or overall size, of the mosaicleum-type columbarium is fixed at the outset, and remains so. For example, for the representative version depicted in FIG. 3A, and the exemplary size given above (the columbarium could be bigger, to accommodate more niches; or smaller to accommodate fewer niches), the total number of niches might be fixed at the outset. The 35 niches would then be filled, over time, as people purchased a given niche (or a perpetual license to place the ashes of a deceased person, or persons, in a given niche; or some other contractual or transactional arrangement). If the columbarium was designed to provide the ability to retrieve the ashes deployed therein, then ashes would likely be placed in an urn, with the urn then being placed in a particular niche or compartment, the cover of which would form part of the art object (in this case a rendering of spheres). Note, too, that each of the niches may be purchased or subscribed to or licensed at the outset (i.e., prior to the mosaicleum-type columbarium being built; or, after), such that the niches are not filled over an extended period of time.

If the columbarium was designed for the permanent deployment of ashes contained therein, then each niche or compartment would be sealed once ashes were placed in the compartment (e.g., by welding; by a permanent adhesive chemistry; and the like). Note that a columbarium may provide the option of either sealing the niche, or remaining accessible, depending on the desires of the person purchasing, licensing, or otherwise gaining access to the niche for the purpose of deploying ashes therein. Note also that the compartments or niches may provide sufficient volume for the storage of memorabilia therein, whether the memorabilia was a possession of the deceased person, or some other object meaningful to the deceased, survivors, or both.

In some versions of the mosaicleum-type columbarium, an individual niche may comprise two or more compartments. These compartments may be used in a variety of ways. For example, if a niche comprised two compartments, then one compartment might be used for the ashes of the deceased (whether placed directly therein, or placed in an urn or other container, which is then placed in the compartment). The other compartment might be used for memorabilia. If a niche comprised three compartments, then one compartment might be used for the ashes of one deceased spouse; another compartment might be used for the ashes of the other deceased spouse; and the third compartment might be used for memorabilia.

Of course the more complex a given niche's design, the more likely that the multi-compartment niche is larger than a single-compartment niche. A columbarium may be designed in which all of the niches are of the same volume and size, and all may be the same in the sense of comprising either one compartment, or two or more compartments. Alternatively, a columbarium may be designed such that different sized niches and/or different types of niches (e.g., one compartment or two or more compartments) are available in a single columbarium.

In some versions of the mosaicleum-type columbarium, the overall size and/or the number of niches contained therein is not fixed. Instead, the columbarium may grow as niches are added. Again turning to the representative version shown in FIG. 3A, additional rows, or columns, or some array of both rows and columns, or individual niches, may be added to the existing columbarium. Typically such additions would be done in a way to preserve the overall appearance of the then existing columbarium. So, for example, a 5-niche (column) by 3-niche (row) may be added on either the left or the right side of the existing columbarium, with a fourth sphere formed by the aggregate of this 5×3 niche array. In this way the overall visual theme of the columbarium is preserved while increasing its capacity from 35 niches to 50 niches (original 35 niches plus the 15 new niches composed of the 5×3 array of niches).

The preceding example defines the niches as generally having a uniform size. As noted elsewhere, the individual niches themselves may be asymmetrical, and of different sizes. So, in FIG. 3A, each of the polygons and other shapes having at least one curvilinear boundary may be an individual niche (with the overall size of the columbarium in 3A being of a size sufficient to accommodate each asymmetric polygon being a niche).

In some versions of the invention, a niche (whether in an artaleum-type, mosaicaleum-type, or other columbarium in the multi-use park) will contain all of the cremated or processed remains of a deceased individual (e.g., with the processed remains placed in an urn or other container, that is then placed in the niche; or with the remains placed directly in the niche). In some cases, however, only a portion of the remains of a deceased individual is placed in a niche. For example, some families may wish to sprinkle or scatter some portion of cremated remains at a location of importance different from the multi-use park (e.g., a family farm; a favorite location at a beach; etc.). The remaining portion would be deployed in the multi-use park. Finally, in some cases, a niche may be paid for, subscribed to, or otherwise accessed . . . but no ashes are deployed in the niche. Instead, the niche serves as a tangible memorial of a person who has passed on (or a pet). As discussed elsewhere, the niche is typically associated with a narrative, perhaps a digitally embodied narrative that is accessible by wireless technology, thereby facilitating remembrance of the person who has passed on (even though the person's ashes are not in the niche). Note, too, that an empty niche may be purchased, subscribed to, or otherwise accessed by survivors who have chosen to bury a loved one at a conventional cemetery. Or an empty niche may be reserved for a deceased historical figure, whether or not the historical figure lived in the community or region where the multi-use park is located. And empty niches, along with a decorative cover, may embody an important historical narrative. So, for example, if a nearby river served an important purpose in the industrial development of a town, the niche cover could in some way depict the river and industrial development (e.g., with an engraving or artistic depiction of a hydroelectric facility) with, optionally, additionally narrative about this development (e.g., a digitally embodied narrative that is accessible wirelessly). In any of the above embodiments, the niche may, or may not, contain other tangible objects (e.g., memorabilia, historical documents, etc.).

As discussed above, some versions of the mosaicleum-type columbarium employ an art form or work that overlies a conventional array of niches. Furthermore, either the overlying art form, or the array of niches covered by the art form, is movable so that ashes, memorabilia, or both may be placed or retrieved from the niches. As with other embodiments discussed above, this overlying art form, and the niches underneath, may be fixed at the outset, or may provide for growth of the columbarium. Furthermore, the individual niches may have the same or different sizes and compartments, and may be designed to be accessible, or permanently closed.

Note also, that in some versions of a mosaicleum-type columbarium, the cover of a niche may change. In one version of a mosaicleum-type columbarium, the cover has one appearance or surface characteristic before ashes are deployed therein, and a different appearance or surface characteristic after ashes are deployed therein. For example, the columbarium depicted in FIG. 3A may take on the form of a wall, perhaps around some or all of the perimeter of the bounded green space of the multi-use park for the living and the dead. For that portion of the wall-type columbarium not yet containing ashes, the cover of the niches might be black, or grey, or have some other unadorned appearance. That portion of the columbarium in which the niches contain ashes might have covers that, as depicted in FIG. 3A, form, in the aggregate, the appearance of spheres. In this version of the invention, the front of the artistically pleasing image might move systematically along the columbarium such that covers behind the front (i.e., behind the boundary between that portion of the columbarium in which niches contain ashes of the dead; and that portion of the columbarium in which the niches are empty) form the depicted image, and those covers in advance of the front (i.e., that portion of the columbarium in which niches are empty) are black. Or the image may be formed piecemeal, over time, as the niches are purchased, licensed, or otherwise obtained. In this way the columbarium is a living art form, changing its appearance over time until it is completed. Thus, in another version of the invention, the columbarium may present one image in an unused state, and, over time, as the niches are used, present a second, different image.

FIG. 3B shows another representative embodiment of a mosaicleum-type columbarium. In this case the perimeter of the columbarium is irregular, compared to the aforementioned version, which is rectangular in shape. Here each of the niches combine to form the appearance of a portion of a stone wall. Or, if made of metal, such as bronze, the covers of the individual niches may have a mottled, hammered appearance. As with the representative version shown in FIG. 3A, the columbarium may be fixed in size at the outset, or may grow over time as additional niches are attached. The niches may be permanently sealed, or have removable covers. Each niche may be the same size and type (e.g., one compartment), or different sizes and types (e.g., some niches of a certain size and having one contiguous volume; other niches of a different size, perhaps comprising two or more separate compartments, which might be used, for example, to keep separate the ashes of two deceased persons, or to keep the ashes of one deceased person and memorabilia; etc.). The columbarium may maintain the same overall appearance, regardless of the number of niches being used. Or the columbarium may change its appearance over time (e.g., used niches, and their corresponding covers or facing, have one appearance when not used; and a different appearance when used). Also, a conventional array of niches, using conventional materials, may underlie an art object, with the columbarium, the art object, or both being movable so that the niches may be accessed for placement and/or removal of ashes, or urns containing ashes. Also, each niche may have disposed on its surface an abstract or recognizable image or object, such as those described above.

Some exemplary versions of a mosaicleum-type columbarium comprise elements in which ashes are blended into one or more materials of construction. As noted above, ashes may be blended in with glass particles and other materials that are then used to make tinted glass. Thus one version of a columbarium may comprise individual panels of tinted glass, one or more of these panels comprising the ashes of a deceased person. Because the amount of ash used in these materials may be less than the total amount of ashes remaining after a person is cremated, columbaria may be designed and constructed so that ashes are used both in materials of construction, and are placed in niches or compartments that are part of the columbarium. In one version of the invention, ashes may be incorporated into glass, which is then used to form features of an abstract, or non-abstract, form. Attached to the glass, or part of some frame or other structure attached to the glass, may be a compartment containing the remaining ashes of the deceased person. The compartment itself may form part of the art form. So, for example, tinted glass incorporating some portion of the ashes of a deceased person may be shaped into the form of flower petals (see, e.g., FIG. 3C), which are then attached to a stem or central portion defining an interior volume in which is placed the remaining ashes of the deceased person. A columbarium, then, may comprise a plurality of such flowers. Furthermore this, like other art-object columbaria described herein, may be attached to the ceiling. Alternatively, a stylized representation of flying birds may comprise tinted glass wings attached to hollow bodies, with ashes both in the tinted glass wings and in the hollow bodies. Many such combinations of glass forms, alone or in combination with compartments, is possible.

It should be noted that, generally, individual signifiers identifying ashes contained in a particular niche, or urn within the niche, will not appear on that portion of the columbarium presenting an aesthetically pleasing art form to the eye. Thus, for example, a mosiacleum-type columbarium will not typically have metal plates, visible to the eye of someone viewing the art object as a whole, on each cover (with, for example, the name, date of birth, and date of death of the person whose ashes contained therein). Instead, such signifiers, if employed, are typically employed so that the aesthetically pleasing image is preserved. This isn't to say, however, that such name plates, or other such signifiers, are never employed on the surface of the columbarium, or individual niches, such that they are visible to the eye of an observer of the art form. Generally, however, such signifiers are not visible.

For those mosaicleum-type columbaria that do not display such signifiers, other ways are available for identifying the persons, or other deceased entities (e.g., deceased pets), in each niche. In one representative version, an electronic device may be associated with each niche, the device comprising a storage element (e.g., random-access-memory (“RAM”) chips; read-only-memory (“ROM”) chips; and other types of memory devices, so long as the information stored thereon is retrievable. Note that devices requiring physical movement, such as the reading of a magnetic disk or optical disk, may be used, but are not preferred. In one version of the invention, radio-frequency identification (“RFID”) technology is employed. An RFID tag is associated with each niche. The tag comprises a storage device, such as a storage element on an integrated chip, on which is stored information relevant to the deceased person(s), pet(s), memorabilia, or the like. The RFID tag may comprise a battery so that information stored thereon is broadcast autonomously. Or the RFID tag may have no such battery, in which case a second device is used to induce a transmission of the stored information. The stored information may include the name of the person whose ashes are contained therein, and a unique identifier corresponding to hard-copy and/or electronic records maintained elsewhere. Alternatively, the tag can contain more information about the deceased person, including the identities of survivors, and other information typically presented in an obituary (e.g., key contributions or life events). Because electronic devices can fail, preferred versions of the columbaria will incorporate other elements to identify the deceased person's ashes contained therein. Likewise, backup systems are deployed to assure all the historical data within the park is backed up and preserved.

For niche covers that are removable, the inside of the cover can include engraved, etched, printed, or otherwise written information identifying the deceased person therein. The information can be disposed directly on the inside of the niche cover, or indirectly, as on a metal or other band that is attached to the inside cover. The information may include the name of the person, or a unique identifier that corresponds to a hard-copy and/or electronic record giving relevant information about the deceased person. Note that this information may be stored in such a way that a password, or other unique identifier, is needed to access information stored on the RFID tag, or on other signifiers (e.g., an etched number on the inner surface of the cover of a niche).

Of course the RFID tag is but one example of an electronic device that may be used to store information about the deceased person whose ashes are stored in the columbarium. Any electronic device capable of broadcasting wirelessly may be used.

Alternatively, a device may be used that requires a physical connection to access the information contained thereon. Any such technology may be used, so long as, for those columbaria in which the signifiers are not visible to an observer of the art form, information about deceased persons and/or pets whose ashes are contained in the columbarium is accessible.

In addition to being an art piece and a columbarium, a mosaicleum-type columbaria can serve additional purposes. A mosaicaleum-type columbarium may form various architectural features of the multi-use park for the living and the dead. For example, such a columbarium may form some or all of a wall that extends along some portion of the perimeter of the bounded green space of the multi-use park. Alternatively, the columbarium may form part of the wall of a building or room. As mentioned above the individual niches may be constructed by comingling the ashes with one or more materials of which a niche, or columbarium, is made. For example a mosaicleum-type columbarium wall around the perimeter of the park may be constructed of niches that appear as stones. Each stone may represent an individual niche. In the unused state the stone may have the look of grey slate stone. Upon use of the niche, the stone may be replaced with one that has been created by comingling the cremated remains with an artificial stone composite to create an artificial colored stone niche that replaces the original gray stone. In this way the wall becomes colored as it fills with those who have passed on, their life stories now associated and RFD accessible with the changing wall (e.g., by making accessible narratives about the persons who have passed on, and whose ashes are now contained in the stone elements of the wall referred to as niches). Likewise an artaleum-type columbarium can be constructed of stone in a similar fashion to form a monument of stacked stone resembling an egg-like shape (FIG. 3D).

### Garden, Architectural, and Landscape Elements

Conventional cemeteries may have walkways, and statuary, within its boundaries. People visiting the cemetery typically walk along these pathways to the site of a grave, where the may place flowers, or pray, or remember. A statue of an important figure from a religious tradition may be in view, adding to the solemnity of the occasion. Such cemeteries serve an important purpose, and may be the preference of certain people, or cultures. A multi-use park for the living and the dead offers a different approach, and thus the elements of the park are different.

For example, a multi-use park for the living and the dead incorporates garden, landscape, and architectural elements that facilitate the desire for community members to be drawn to the space for ongoing use of the park for purposes other than deploying and remembering the dead. As stated elsewhere, the multi-use park melds ongoing life events with the sole purpose that is typically the focus of traditional cemeteries. To break with images and symbols that call to mind this single purpose—remembering the dead—intact bodies of dead people or pets are excluded from the multi-use park. As discussed elsewhere, interred bodies, marked by tombstones, in symmetrical fashion, are a traditional design and image associated with cemeteries. The multi-use park avoids this approach, even though it will continue to remain the preference of some segment of a given population. And that is fine, and appropriate, for those who wish to handle end-of-life arrangements in this way.

The multi-use park for the living and the dead, on the other hand, offers a different approach. And the design and elements of the park reflect this approach. Just like a cemetery, the multi-use park will typically include one or more walkways through the bounded green space. Unlike a cemetery, the walkway, and elements along the walkway, facilitate activities other than remembering the dead: sitting on a bench, reading, in a quiet garden; eating a picnic lunch by a fountain; having a picnic on a sunny day, in the shadow of a large, abstract, metal sculpture—which is also a columbarium; holding a celebration in a pavilion or community building; playing chess at an outdoor table; taking pictures of swans or ducks paddling across a pond; meditating on the beauty of another sculpture, in this case a series of spheres on the ground, which may, in an unobtrusive way, contain the ashes of those who have passed on, whether the person meditating on the beauty of the sculpture knows this, or not.

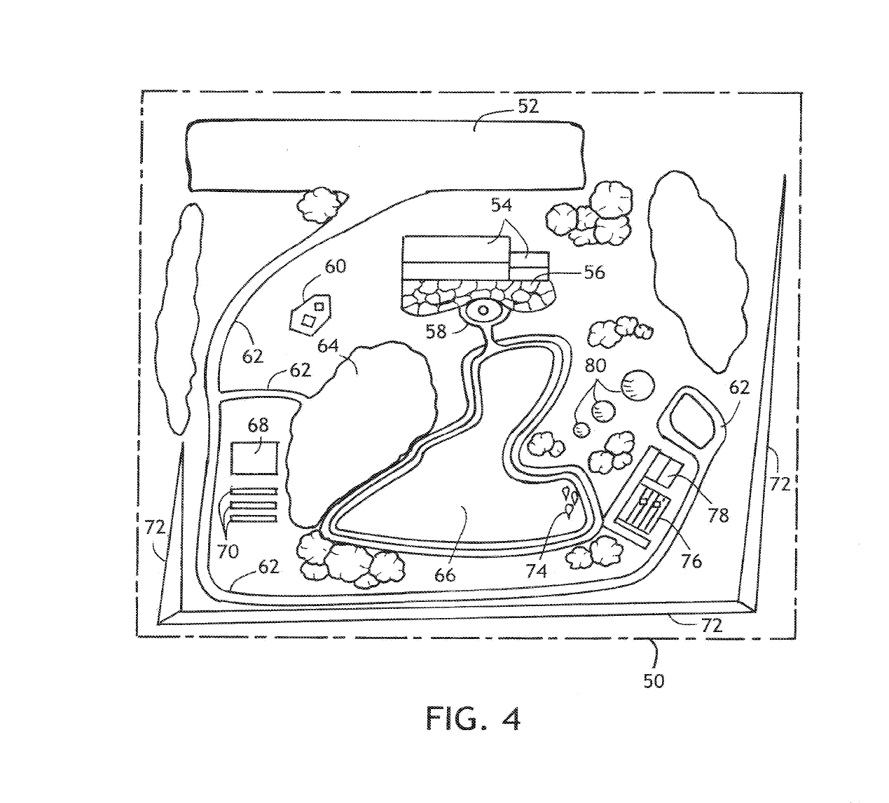

In some representative versions of the park, the garden, landscape, and architectural elements divide the multi-use park into portions having different focal points for the living. FIG. 4 shows one representative multi-use park for the living and the dead. The park is defined by a perimeter 50, which serves as the boundary for the bounded green space. Often this perimeter will substantially coincide with the legal boundary, or some portion thereof, of a parcel of property. While the perimeter shown in FIG. 4 defines a rectangular area, this need not be so. The perimeter may be curvilinear. Typically the perimeter of the park will be enclosed by a mosaicleum in the form of a wall that encloses the space in part or in entirety.

Typically the multi-use park will include a conveniently located parking lot 52 with access to one or more roads. Furthermore, preferred versions of the park include a building 54 in which various life-continuum events may be held; especially those events considered generally to be important milestones along the continuum of life: baptism celebrations, birthdays, coming-of-age ceremonies (e.g., first communions), graduation ceremonies, weddings or receptions, retirement celebrations, and the like. Accordingly, the building 54 may include a kitchen area; wet bar; hall capable of accommodating 50, 100, 200, or 500 or more people; stage or other platform for performances; and other such features. As discussed elsewhere, the building may include an artaleum-type columbarium, a mosaicaleum-type columbarium, an inside garden, as in a greenhouse, in which ashes may optionally be sprinkled, or some combination thereof. Furthermore, the building may include state of the art electronic devices for accessing narratives, telecasting the event, recording the event, etc., about those who have passed on, and whose ashes are deployed in the multi-use park (or for other events held in the space, such as weddings). As is discussed elsewhere, such devices may be multi-purpose computers that, at least in part, are used to retrieve and display information about those who have passed on; and, preferably, other narratives, such as narratives about the history and significance of the region and community in which the multi-purpose park is located; narratives about the various life events, such as weddings, that have been conducted or celebrated in the multi-use park; and the like. Also, such information may be broadcast wirelessly for reception by portable computers, smart phones, and other similar electronic devices capable of receiving, and displaying, information carried by these wireless transmissions. Alternatively, or in addition to, the information presented using these electronic devices, tangible articles, such as plaques and statutes, may be used to present narratives about the living and the dead. As discussed elsewhere, in some cases visible signifiers of the dead are generally kept to a minimum, but are nevertheless accessible (e.g. electronically). In some versions of the multi-use park, electronic devices may be used to enter information that is then stored for retrieval by others. For example, an on-going blog pertaining to a deceased person whose ashes are deployed in a mosaicleum-type columbarium may be kept, and attached to, a record corresponding to the deceased person. This record, or parts thereof, including the aforementioned blog, may be securely kept so that only family members, or close friends, have access (e.g., by entering a password). Or the blog and record may be open to the public, depending on the wishes of the family. The same may be said of important life events celebrated or commemorated in the multi-use park. Electronic records may be created and stored for later access by a select group, or by the public at large.

In this particular version of the multi-use park, an outdoor patio 56, and a fountain 58, are located near the building 54. Access to the patio may be restricted to attendees of a celebration or other life event held in the building on a particular date. Note too that the fountain itself, consistent with the embodiments of columbaria discussed above, may be a columbaria in which ashes of the dead are deployed, either in niches, in urns in niches, or as part of the materials of construction of the fountain. Furthermore, water from the fountain may wend its way into a pond or body of water 66.

An overhead view of an artaleum-type, abstract columbarium 60, such as the sculpture depicted in FIG. 2B or 2D, may be quite large (e.g., 10 to 20 feet high; or even larger, such as 20 to 30 feet high). In this way the sculpture, perhaps in an open, grassy area, serves as an aesthetic focal point, visible from afar. People in the multi-use park walk, and laugh, and celebrate, nearby. Yet the columbarium 60 contains ashes of the dead, so that life events, and the dead, and remembering the dead, are melded together in one public space, in close proximity to one another.

A path 62 allows people to walk around the park. In one case, the path 62 goes into a more heavily wooded area 64, which borders a body of water 66. This wooded area my include other elements, such as a sprinkling garden for ashes (not shown), benches (not shown), stepping-stones or a walkway, and other such garden or landscape features.

Also shown in this representative version of a multi-use park for the living and the dead is a pavilion 68, and benches 70. This area may be used for outdoor concerts and other such activities or performances.

As noted and described elsewhere in this document, a mosaicleum-type columbarium 72 may form part of a wall located at or near a park boundary. In this particular version of the park, the wall is depicted as an angled, geometric shape, akin to the Vietnam memorial in Washington D.C. The wall can be made of various materials (the wall itself is presented in a simplified form in the figure; the actual wall typically would be asymmetrical in form.) For example, the wall may be constructed of metal, such as bronze, brass, or steel; or stone, such as granite or marble; glass; non-traditional materials such as plastic, glass, or a concrete-based composite; or other building materials, including combinations thereof. Of course for those columbaria located outside, the design and materials of construction account for the temperatures ranges and weather conditions typical of the area where the park is located. In some versions of the park, this columbarium may be added or extended to over time. Also, the appearance of the columbarium may change (e.g., with those portions of the columbarium prior to deployment of ashes therein having one appearance; and with those portions of the columbarium after use—i.e., after ashes of a deceased person have been deployed—having a different appearance). It should be noted, also, that depending on the size of a mosaicleum-type or artaleum-type columbarium, the columbarium may include 100 to 1000 individual niches. In some cases the columbarium (e.g., a wall) may include thousands of individual niches.

This version of a multi-use park includes an artaleum-type columbarium 74 having the appearance of heron-like birds, like that depicted in FIG. 2A. Here the heron-like columbarium is located in the water 66, although this need not be the case. If maintenance of, and access to such a columbarium is burdensome, then, in this case, the columbarium may be such that the ashes deployed therein are not retrievable, and the columbarium is placed only after all niches contained therein have been purchased or subscribed, and therefore used. Alternatively, this type of columbarium may be designed to not include individual niches, and instead include ashes of the dead in one or more materials of construction. Finally, instead of a columbarium, this image of heron-like birds may simply be an aesthetically pleasing sculpture.

This embodiment of a multi-use park includes a Japanese-style rock garden 76, in which smaller rocks are raked so that a geometrically pleasing pattern is seen. For example, the rocks or pebbles may be raked to form substantially parallel lines. Or larger rocks may be placed as islands in the bed of smaller rocks and pebbles, with raked lines around these islands mimicking waves that might be seen around an island in a lake or ocean. Nearby is a second pavilion 78.

The arrangement of three spheres depicted in FIG. 1A is present in this embodiment of a park as the artaleum-type columbarium 80. As with other columbaria, this particular columbarium could be added to over time (e.g., by adding one or more additional spheres).

The preceding paragraphs provide a description of a representative multi-use park for the living and the dead. Unlike traditional cemeteries, ashes of the dead are deployed in aesthetically pleasing, often asymmetrical, art forms, such as the artaleum-type columbarium, and the mosaicleum-type columbarium. Rather than isolating the ashes of the dead from activities of the living, these columbaria are located throughout the park. Furthermore, the park includes elements that facilitate ongoing events of the living in close proximity to the stored ashes of the dead (e.g., a building or hall that can accommodate life events such as weddings). And the park can include landscape and garden design elements that help partition the park into different focal areas that facilitate different life activities, while preserving an overall harmony among its features. Thus gardens, hedges, copses of trees, evergreens, and other plantings may be used to create semi-private areas within the park, helping facilitate group activities (e.g., family picnics; an open-air chess tournament in an open pavilion; disk golf) apart from other activities and areas within the park. Certain design techniques may be used to present or help induce contemplative or other feelings among those using the park. For example, evergreen plantings may predominate in some portions of the park, thereby helping evoke the feeling or perception of ongoing life, year round. For the same reason, the color green may predominate in the park (at least in those geographic locations where the color green predominates; as noted elsewhere, in some locations, e.g. the American Southwest, other colors and flora may be deployed, consistent with regional influences and appearances, such that the color green does not predominate). Also water can be deployed in various ways, either statically (e.g., ponds) or dynamically (e.g., waterfalls, fountains). Water, especially in a calm state, reflects that which is around the water, and can help to relax and cleanse a person's mind. For example, a cafeteria locating in the building, and adjacent to the patio and water, could serve as a meeting place for community members to come together. In effect, the multi-use park can become a destination akin to a town square.

### Narratives

Life may be viewed, in part, as a narrative in which a person is an active participant. He or she makes decisions, speaks and writes, works, acts, creates, befriends and loves others—all of which is part of that person's narrative. Thus, over time, a person participates in and helps create a story. And each person's individual narrative intertwines with other narratives to form a grander narrative (e.g., of a family; of a workplace; of a community). The multi-use park—a space in which receiving and remembering the dead is melded with life-affirming structures and practices—makes available these narratives.

A multi-use park for the living and the dead can embody narratives in conventional, tangible form such as plaques, memorials, realistic sculptures of figures and events past, and the like. Such forms likely limit the narrative to something simple and short, perhaps no more than the name, date of birth, and date of death of a deceased person; or a few sentences, engraved in a plaque, about an important historical event.

Individual niches may include engravings, small metal plaques, or other such signifiers of the dead placed therein (e.g., the name, date of birth, and date of death). Of course this makes immediately clear that what might otherwise be viewed solely as an art object is also a structure containing ashes of the dead. In some versions of the multi-use park, signifiers of the dead are visible. In other versions of the multi-use park, such signifiers are not immediately visible. One way to make such signifiers less visible (in addition to, or as an alternative to, placement of such signifiers in a location where the signifier cannot be readily seen, such as the inside of the cover of a niche) is to provide information in electronic form.

In one version of a multi-use park, these narratives are stored on a multi-purpose computer (e.g., a centrally located server). Information reflecting each narrative is stored digitally and corresponds to text, images, and sound. Examples of narratives that might be stored include narratives of deceased persons whose ashes are located within the boundary of the green space of the multi-use park; narratives of surviving family members and friends; narratives of one or more living persons associated with nearby communities, the region in which the green space is located, or both; narratives corresponding to the history of any nearby communities, the surrounding region, or both; narratives on people groups; narratives on nations; narratives relating to various milestone events celebrated in the multi-use park, such as weddings or graduation celebrations; and the like.

In the case of a deceased person whose ashes are deployed in the multi-use park, a record may be created that corresponds to that deceased person. Pictures, sound recordings, and statements reflecting the life of the deceased person may be entered in various ways, including: entering information on a keyboard so that the entered information is stored on the server (or like device); scanning in text or images and transmitting the resulting digital documents (e.g., in .pdf file or other format) to the server; attaching a portable memory device such as a flash memory card to the server so that information on the portable memory device is transferred to and stored on the server; wirelessly transmitting information from a portable computer or other device to the server; transmitting the information over the Internet, or a local area network, or any such network, so long as the desired information is transferred to and stored on the server. It should be noted that information may be inputted locally (e.g., into the server itself, directly or via a device connected to a local-area network, and from the same geographic location) or from a remote location (e.g., a user, from his or her own home, connecting to the server via the Internet, and, accordingly, transmitting and receiving information over the corresponding communications network).

As noted above, the stored information will typically be associated with a record linked to the deceased person's name. In the same general manner that text, sound files, video files, static pictures, and the like may be attached to a Web page, and accessible to viewers of the Web page, these same types of informational content, and manner of presenting said content, can be used to present a narrative about the deceased. Thus, for example, a static Web page (or Web-like page) may presented, on which is disposed one or more digitized photographs of the deceased; a list of surviving family members; and text providing a general synopsis of that person's life (which may be created by the individual or friends and family of the individual). A more dynamic Web page might include video of the deceased and/or a sound recording of the deceased. Of course such content requires more memory, and likely greater rates of information transmission, and thus the cost of the hardware, and perhaps software, needed to store and transmit dynamically-presented information is higher.

In one version of the invention, a record, or portions thereof, would be publicly accessible. Alternatively, the record, or portions thereof, could be accessible only to people who could authenticate their identity and/or hardware; and/or who had the appropriate password. In this way people in the multi-use park, or far from it, could add text, images, or sound to the deceased person's record over some span of time. For example, a thread of text entries might be kept in which people wrote their thoughts and feelings about the person who has passed on. This of course presumes that these individuals are authorized to add, or edit, information associated with a given record. In some versions of the invention, the record would be locked such that no one except a network administrator, or other such person, could edit a record after a given date. Instead, the public at large, or only those who were properly authenticated (e.g., by providing a password; or by having a digital certificate on their hardware device, coupled with procedures for authenticating the user employing the digital certificate) could access the information, but only in read-only form.

This stored information may be accessed in the same ways that information is inputted: wirelessly or via wired connections; locally, either directly to the server, or indirectly through another device connected to the server (as with a local area network to which the server is connected); remotely, as with operation of a remote personal computer receiving information from, and transmitting information to, the server over the Internet; using portable storage devices such as flash memory cards; and other such devices.

In one representative embodiment, narratives comprising digitally stored information like that described above are accessed wirelessly by portable devices (e.g., via a Wi-Fi network). So, for example, visitors to the multi-use park might use personal portable devices, such as a mobile phone with a visual display, to wirelessly access one or more records stored on the server. In one representative embodiment, these portable devices would be used to access a map, or maps, of the multi-use park. Users, then, could display the map at different scales (e.g., from a scale in which a map of the entire bounded green space was displayed, to a scale in which locations of interest could be identified, including the location of a specific niche containing the ashes of a deceased person). In some versions of the invention, the displayed map would include links that a user could activate by, for example, clicking on or touching the link (e.g., with a finger or stylus), thereby opening the link and accessing information (e.g., the link might correspond to the location of a specific niche, and activating the link would then result in information being displayed about the deceased person whose ashes were contained in the niche).

In an alternative embodiment, a hardware device associated with each niche facilitates the display of information associated with the deceased person whose ashes are contained therein. As noted earlier, an RFID tag could be associated with each niche. The RFID tag might have its own power source, such that the tag autonomously broadcast information stored thereon to other devices. Or the RFID might not have its own power source, in which case another device would have to serve as a triggering device for transmitting information stored on the RFID. In either case, the RFID itself may contain some or all of the narrative information pertaining to the person whose ashes are stored therein. Or the RFID might transmit some identifier corresponding to a given record stored elsewhere. A portable device in the vicinity of the RFID, and enabled to receive and process information transmitted by the RFID tag, would then retrieve information from the server corresponding to the information received from the RFID tag.

In the case of a columbarium containing multiple niches, with multiple RFID tags broadcasting information, the user of the portable device would have to make a selection as to the desired record. Thus, for example, the RFID tag might broadcast, in digital form, the name of the person (or pet) whose ashes are contained in that niche. A user of a portable device in the vicinity of the niche would then have displayed on that device a list of names, from which the person would make a selection in order to obtain the narrative information corresponding to that deceased person (e.g., via a Wi-Fi connection to the server).

In some versions of the invention, a portable device with a camera may be used to display, on screen, a view of that which appears before the portable device. For scales greater than 30 feet, which are capable of being resolved using GPS technology, and for portable devices that also incorporate a GPS capability and/or compass, the device can overlay objects appearing in the image with small tags. So, for example, a user may use the device in the multi-use park to overlay a large-scale object with a tag about the object. Thus a user in proximity to a large scale columbarium, like that displayed in FIG. 1B (assuming, for this discussion, that the depicted artaleum-type columbarium was 25 feet high), and using a portable device with a camera and display screen to view the columbarium, then a small tag, such as colored oval, might appear over a portion of the displayed columbarium. In other words, the portable device's GPS capability and/or compass provide location-specific information about that which is displayed on the portable device's screen—in this case the columbarium—and interactive wireless transmissions between the portable device and other devices, such as one or more servers, over a communications network, overlays the columbarium with the colored oval. Information such as the artist's name, the name of the work of art, or other information might be displayed on the oval. Furthermore, the oval may serve as a hyperlink to other information accessible wirelessly over the communications network. A user, activating the link (e.g., by touching the screen with a stylus or finger), would then have other content displayed on the screen. Because, in this case, the large-scale object (in this case “large scale” refers to objects that are sufficiently large to be resolved using the civilian capabilities of GPS technology) is an artaleum-type columbarium, then the additional content may be in the form of a representation of the columbarium, but now displayed in a form so that individual niches of the columbarium, and their location on the columbarium, may be seen. The user, then, using either the location of a specific niche on the displayed columbarium, or using another signifier (e.g., the names of the deceased persons whose ashes are stored in the columbarium), could then, in some versions of the invention, select that niche location, name, or other signifier to access narrative information about the deceased person whose ashes are stored in the columbarium.

In addition to, or as an alternative to, wireless access to narrative content using portable devices at different locations in the multi-use park, computers or devices that are hard wired to a network may be used to access and display such narratives. For example, one or more computers in a building located in the multi-use park may be used to access various narratives about the deceased whose ashes are stored in the multi-use park. And, as noted above, these computers may be used to access numerous other narratives that intertwine with those of the dead including, for example: stories about life celebrations conducted at the park, including weddings, birthdays, graduations, retirements, and the like; narratives about people in nearby communities or in the surrounding region; stories about historical figures; narratives about important events; etc. The information may be displayed in ways similar to those described above, including: text-only presentations; mixtures of text and images akin to static Web pages; text, images, video and/or sound, akin to dynamic content on Web pages; an overall map of the multi-use park, which, in some embodiments, may be viewed at different scales, allowing a user to view specific locations or objects in the multi-use park; and the like.

### Methods of Using a Multi-Use Park for the Living and the Dead

The present invention also encompasses methods of using the multi-use park for the living and the dead. In some versions, the method encompasses for-profit operation of the green space. Thus, in one representative embodiment, the method includes the steps of: (a) deploying ashes of a previously existing entity within the bounded green space of the multi-use park; (b) receiving payment for said deployment; (c) accommodating a milestone life-continuum event within the bounded green space different from step (a); and (d) receiving payment for said accommodation. Because this version of the invention reflects a for-profit entity or entities, steps (b) and (d) are taxable events at one or more levels of government (e.g., local, regional, state, or federal). Furthermore, steps (a) and (c) are not necessarily segregated from each other in time or space. As noted above, ashes of the dead may be deployed in a variety of artaleum-type or mosaicaleum-type columbaria located through out the multi-use park. Thus, in a private setting within the park, such as a garden setting for solitude, the setting might include a bench structure having niches in which ashes of the dead are deployed. Or, in an outdoor amphitheater adapted for theatrical or musical performances, a mosaic-type columbarium may form part of the amphitheater, or a part of a wall near the amphitheater. Or, in a building used to accommodate weddings or other such celebrations and events, a mosaicaleum-like columbarium having the appearance of an abstract painting may be present in the building (e.g., on a wall in the building). In all of these cases, life events occur along side ashes of the dead, in contrast to traditional cemeteries where the dead are segregated, typically in symmetrical fashion within a quadrant, apart from the living. Note too that the method implicates a multi-use park for the living and the dead in which non-cremated remains of previously existing entities are not deployed.

Representative methods of using the multi-use park may also include the step of paying income, likely in some manner proportional to the amount of received payments or fees. Income may be paid to a sole proprietor, one or more partners, an agent of a corporation, a franchisor, or other person or entity. If income is paid to a franchisor, then the method may be carried out in different geographic locations by a plurality of franchisors. In some representative methods of using the multi-use park, the method is carried out under the same trade name.

Typically the ashes of a deceased entity are deployed in an artaleum-type or mosaicleum-type columbarium located within the bounded green space of the multi-use park for the living and the dead.

Representative methods of using the multi-use park also typically include the step of providing a narrative about one or more of the deceased entities deployed within the bounded green space of the multi-use park. In some versions of the invention, at least a portion of these narratives is available over a communications network, whether wirelessly, over wire, or both.

Representative methods of using the multi-use park can also include the step of providing a narrative about one or more milestone life-continuum events celebrated within the bounded green space of the multi-use park. Examples of such events include a baptism, a confirmation, a coming-of-age event, a graduation, a wedding, an award, or a retirement. In some versions of the inventive method, a building located within the bounded green space of the multi-use park accommodates the milestone life-continuum event.

In some versions of the inventive method, the method is not for-profit, but instead produces funds to offset non-profit or governmental operation of the multi-use park. Thus, in one representative embodiment, the method includes the steps of: (a) deploying ashes of a previously existing entity within the bounded green space of the multi-use park; (b) receiving payment for said deployment; (c) accommodating a milestone life-continuum event within the bounded green space different from step (a); and (d) receiving payment for said accommodation. Because this version of the invention reflects a non-profit entity or entities, steps (b) and (d) are not taxable events at one or more levels of government (e.g., local, regional, state, or federal).

Representative methods of using the multi-use park may include the step of using some portion of the received payments to offset the cost of operating the park (e.g., maintenance, labor, utilities, etc.) and/or fixed costs.

Note generally that with any method of using the park, received payments or fees may be used not only to offset or cover the cost of operating the park and/or fixed costs, but to help support and underwrite other organizations that serve the community (e.g., United Way, alone or in combination with specific organizations to which United Way serves as a channel for charitable funds). Thus in some versions of the invention, some portion of the received fees is transmitted to other organizations, such as non-profit organizations, especially those that serve the community in which the multi-use park is located (or communities near the multi-use park).

As with for-profit operation, the ashes of a deceased entity are typically deployed in an artaleum-type or mosaicleum-type columbarium located within the bounded green space of the multi-use park for the living and the dead.

Similarly, representative methods of using the multi-use park also typically include the step of providing a narrative about one or more of the deceased entities deployed within the bounded green space of the multi-use park. In some versions of the invention, at least a portion of these narratives is available over a communications network, whether wirelessly, over wire, or both.

Representative methods of using the multi-use park in a non-profit manner can also include the step of providing a narrative about one or more milestone life-continuum events celebrated within the bounded green space of the multi-use park. Examples of such events include a baptism, a confirmation, a coming-of-age event, a graduation, a wedding, an award, or a retirement. In some versions of the inventive method, a building located within the bounded green space of the multi-use park accommodates the milestone life-continuum event.

Whether the multi-use park is operated in a for-profit or non-profit fashion, payment need not be received for all acts of deploying ashes within the bounded green space, or all acts of accommodating a milestone life-continuum event. Furthermore, representative methods of use may restrict receipt of payment to deploying ashes only (e.g., receive payment only for the step of deploying ashes within the bounded green space, while accommodating milestone life-continuum events of the public, e.g., members of the community in which the multi-use park is located, at no charge).

Note too that messages may be transmitted to potential customers or users of the multi-use park. In some representative versions, a method of transmitting a message about the multi-use park includes the steps of: underwriting, at least in part, a reality video embodied in a tangible medium, wherein the video serves as indicia of a multi-use park for the living and the dead; and underwriting, at least in part, transmission of the reality video. Underwriting a reality video means that the video is paid for, at least in part, by a person or entity seeking to transmit a message about the multi-use park. Either the person or entity seeking to transmit the message will pay for, and create, the reality video itself. Or, as is more likely, the person or entity seeking to transmit the message will engage one or more other parties to create the reality video. Furthermore, the person or entity underwriting, at least in part, creation of the reality video will either transmit the reality video directly (e.g., by posting the video on a Web site owned by the person or entity). Or the person or entity underwriting the creation of the reality video will pay other parties to transmit the message (e.g., broadcast the message on television, typically over cable networks; broadcast the message through streaming video available over the Internet, etc.). The term “reality video” refers to those programs in which at least some of the videotaped participants are not professional actors, but instead are people from different walks of life who are selected to participate in the video (typically through a process in which the participant applies in some way to be a participant, is interviewed or screened, and is then selected to participate). The term “indicia” refers to any audible or visual element that serves as a reference to the multi-use park including, for example: a statement about the park, its operation, its design, or its elements; a statement about a mosaicleum-type or artaleum-type columbarium; a statement that refers generally to the melding, in one space, of activities of the living along side the remains of the dead; a statement that includes any tradename or trademark or service mark associated with the multi-use park; any statement referring to placement of the remains of a loved one in the multi-use park; any visual representation of the preceding statements; any visual representation of a multi-use park or activities in it; and the like. In effect, any conventional technique for advertising and marketing a service or good, if employed in a reality video for the purpose of promoting a multi-use park for the living and the dead as described in this document, may be used in the video as indicia of the multi-use park. Note, too, that the method encompasses persons or entities undertaking the above activities directly, without engaging any other party. Thus, in another version of the invention, a method of transmitting a message about the multi-use park includes the steps of: creating a reality video embodied in a tangible medium, wherein the video serves as indicia of a multi-use park for the living and the dead; and transmitting the reality video.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

I claim:

1. A bounded green space for the living and the dead, the bounded green space comprising an artaleum-type columbarium, the artaleum-type columbarium comprising an asymmetric structure having niches, wherein each niche is adapted to contain ashes of a deceased entity.

2. The bounded green space of claim 1, the bounded green space further comprising a building for accommodating a milestone life-continuum event.

3. The bounded green space of claim 1 wherein the artaleum-type columbarium is a sculpture.

4. The bounded green space of claim 1, wherein the bounded green space comprises a plurality of artaleum-type columbaria.

5. The bounded green space of claim 1 further comprising a mosaicleum-type columbarium, the mosaicaleum-type columbarium comprising an asymmetric combination of niches, wherein each niche has a different appearance and is adapted to contain ashes of a deceased entity, and wherein the combination of niches cooperate to form a mosaic theme.

6. The bounded green space of claim 1 wherein the number of deceased entities deployed per acre of green space is between 300 and 2000.

7. The bounded green space of claim 1 further comprising narratives of the living, the dead, or both, wherein the narratives are embodied in electronic form.

8. The bounded green space of claim 7 wherein at least some portion of the available narratives are accessible wirelessly.

9. A method of using a bounded green space for the living and the dead, the method comprising the steps of:
(a) deploying ashes of a previously existing entity within the bounded green space;
(b) receiving a fee for said deployment;
(c) accommodating a milestone life-continuum event within the bounded green space different from step (a); and
(d) receiving a fee for said accommodation;

10. The method of claim 9 wherein a portion of the received fees are used to support a community organization.

11. The method of claim 9 wherein the milestone life-continuum event is a community event.

12. The method of claim 9 wherein the cremated ashes are deployed in an artaleum-type columbarium, the artaleum-type columbarium comprising an asymmetric structure adapted to contain ashes of a deceased entity.

13. The method of claim 12 wherein the artaleum-type columbarium is a sculpture.

14. The method of claim 9 further comprising the step of providing, within at least some portion of the bounded green space, a narrative about one or more of the previously existing entities.

15. The method of claim 9 wherein the narrative is accessible over a communications network.

16. A columbarium comprising ashes of a previously existing entity, wherein the columbarium is an asymmetric structure comprising niches adapted to contain ashes of a deceased entity.

17. The columbarium of claim 16 wherein the ashes are reduced in mass, volume, or both prior to storage in the columbarium.

18. The columbarium of claim 16 wherein the ashes are reduced in mass, volume, or both prior to incorporation into a material of construction composing the columbarium.

19. The columbarium of claim 16 wherein the columbarium is a sculpture.

20. The columbarium of claim 16 further comprising a narrative that is accessible wirelessly.
